(19) United States
(12) Patent Application Publication
(10) Pub. No.: US 2018/0263844 A1
(43) Pub. Date: Sep. 20, 2018

(54) Pleasure Clasp Device

(71) Applicant: Darryl Robert Schoon, Tucson, AZ (US)

(72) Inventor: Darryl Robert Schoon, Tucson, AZ (US)

(21) Appl. No.: 15/914,545

(22) Filed: Mar. 7, 2018

Related U.S. Application Data
(60) Provisional application No. 62/471,625, filed on Mar. 15, 2017.

(51) Int. Cl. A61H 19/00; A61H 23/02

(52) U.S. Cl. CPC A61H 19/44; A61H 2201/165; A61H 2201/5007; A61H 23/02

(57) ABSTRACT

A pleasure clasp device may include a dildo having a first end and a second end. The dildo may be coupled to a clasp with a movable coupling. The clasp may have a first arm and a second arm, and the first arm and second arm may be coupled together via a base. The movable coupling may be configured to couple the second end of the dildo to the clasp and to enable the first end of the dildo to be moved relative to the clasp. The clasp may be adapted to be secured to the user by inserting the second arm into the vagina and in contact with the anterior wall of the vagina and by placing the first arm in contact with the clitoral region so that the pubis symphysis region of the wearing user is positioned and held between the first arm and second arm. In this manner, the clasp may grip the pubis symphysis region thereby securing the device to the wearing user in a hands-free manner.

### CROSS REFERENCE TO RELATED APPLICATIONS

This application claims priority to and the benefit of the filing date of U.S. Provisional Application No. 62/471,625, filed on Mar. 15, 2017, entitled “Pleasure Clasp Lightweight Dildo”, which is hereby incorporated by reference in its entirety.

### FIELD OF THE INVENTION

This patent specification relates to the field of adult sexual devices. More specifically, this patent specification relates to adult sexual devices which may be removably secured to portions of the body of a user.

### BACKGROUND

Phallic devices, sometimes referred to as dildos, have been known and used throughout the centuries. It is a common practice for women to use these devices when engaging in sexual activity with a partner. Some of these devices include a harness to which the dildo is affixed, and the harness is secured around external portions of the user. These harness devices can be difficult to position correctly and the harness may cause chaffing or irritation. Other devices, such as double-ended dildos, include one or more dildos which may be simultaneously inserted into both partners. However, these devices tend to slip out and/or move in ways not in synch with their movements due to their weight and often linear shape.

Therefore, a need exists for novel adult sexual devices. A further need exists for novel adult sexual devices which enable a dildo to be secured to a woman without requiring a harness. There is also a need for novel adult sexual devices which enable a dildo to be controlled and worn by a woman to be in synch with their movements.

### BRIEF SUMMARY OF THE INVENTION

A pleasure clasp device is provided. In some embodiments, the device may include a dildo having a first end and a second end. The dildo may be coupled to a clasp with a movable coupling. The clasp may have a first arm and a second arm, and the first arm and second arm may be coupled together via a base. The movable coupling may be configured to couple the second end of the dildo to the clasp and to enable the first end of the dildo to be moved relative to the clasp. The movement provided by the movable coupling allows the dildo to move in synch with the movements of a wearing user while enabling the clasp to be stably secured to the wearing user.

In further embodiments, the clasp may be adapted to be secured to the user by inserting the second arm into the vagina and in contact with the anterior wall of the vagina and by placing the first arm in contact with the clitoral region so that the pubis symphysis region of the wearing user is positioned and held between the first arm and second arm. The pubis symphysis region may include the tissue of the wearing user located generally between the clitoral region and anterior wall. In this manner, the clasp may grip the pubis symphysis region thereby securing the device to the wearing user in a hands-free manner.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a top perspective view of an example of a pleasure clasp device according to various embodiments described herein.

FIG. 2 illustrates a bottom perspective view of an example of a pleasure clasp device according to various embodiments described herein.

FIG. 3 shows a front elevation view of an example of a pleasure clasp device according to various embodiments described herein.

FIG. 4 depicts a perspective exploded view of an example of a pleasure clasp device according to various embodiments described herein.

FIG. 5 illustrates a side elevation view of an example of a pleasure clasp device secured to a woman according to various embodiments described herein.

FIG. 6 shows a sectional, through line 6-6 shown in FIG. 6, elevation view of an example of a dildo according to various embodiments described herein.

FIG. 7 depicts a block diagram of some components of an example of a pleasure clasp device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

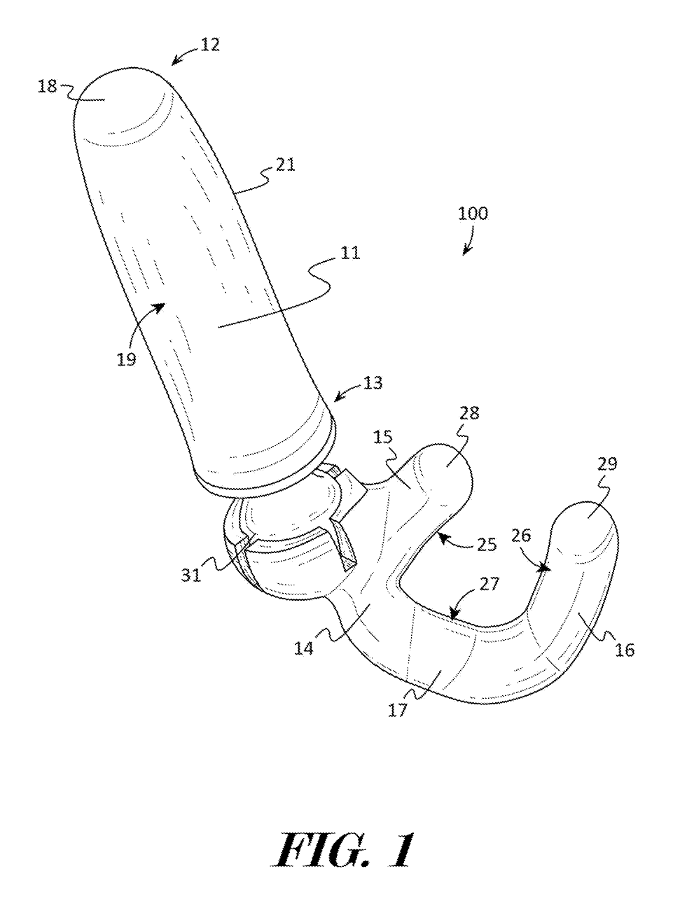

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new adult sexual device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

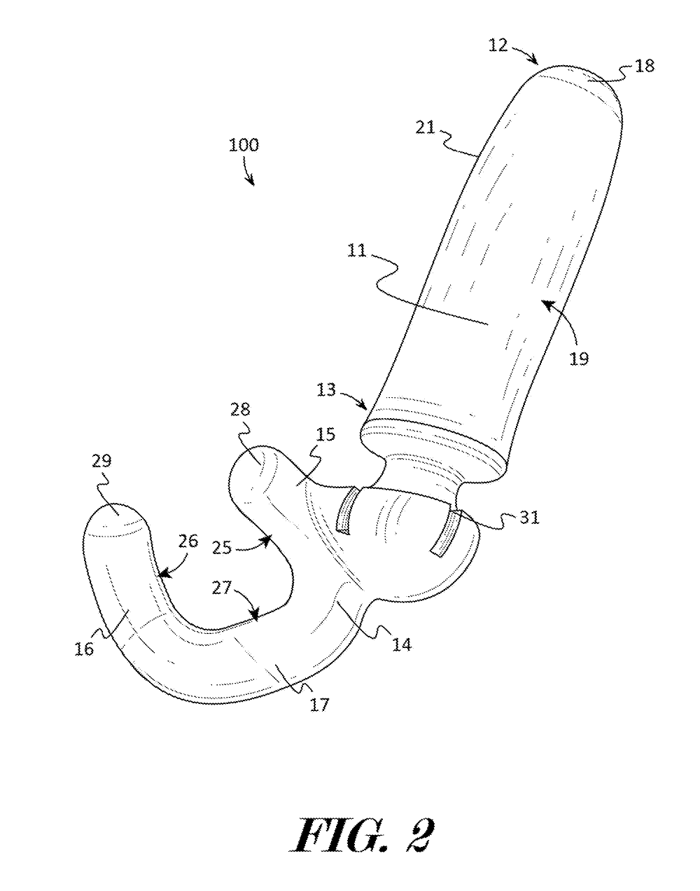

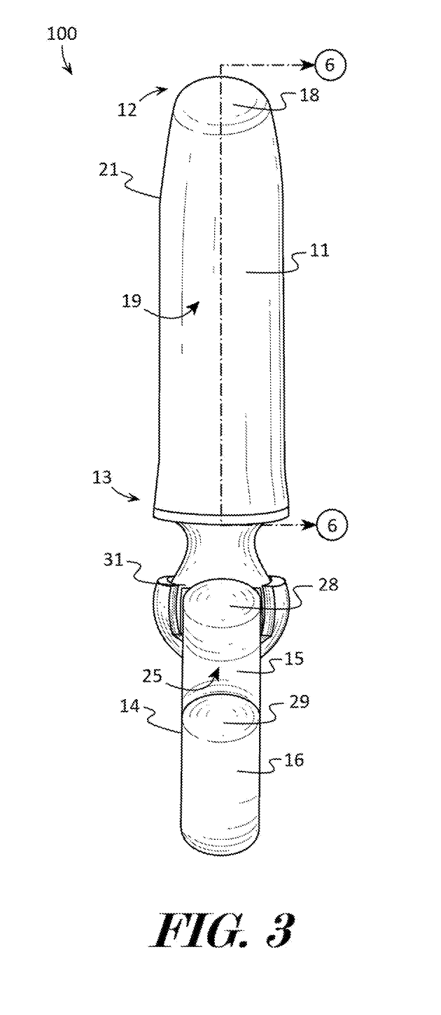

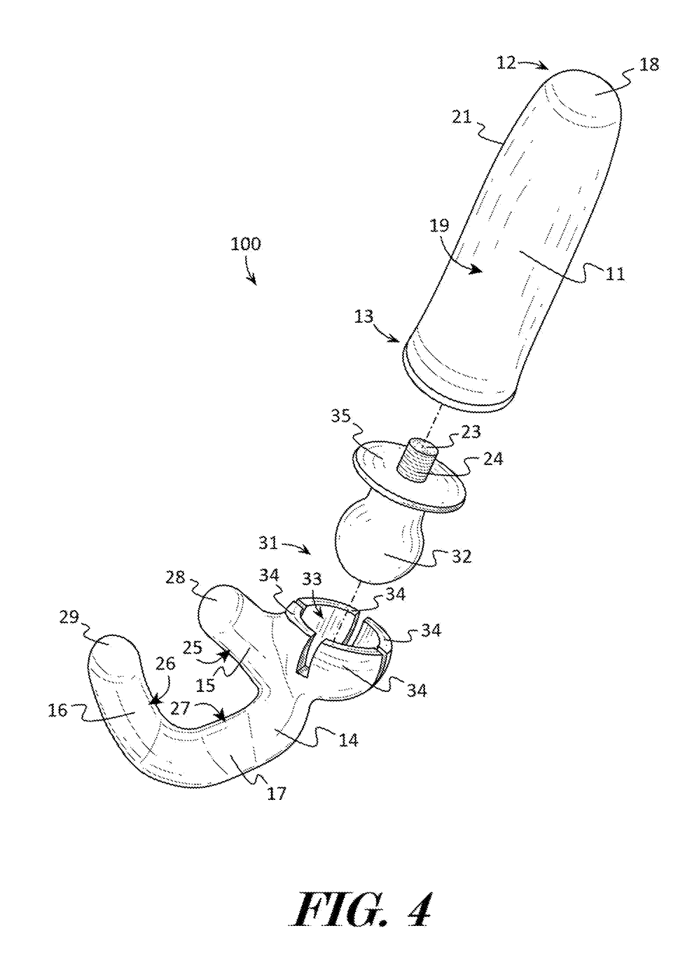

The present invention will now be described by example and through referencing the appended figures representing preferred and alternative embodiments. FIGS. 1-5 illustrate an example of a pleasure clasp device (“the device”) 100 according to various embodiments. In some embodiments, the device 100 may comprise a dildo 11 having a first end 12 and a second end 13. The dildo 11 may be coupled to a clasp 14 with a movable coupling 31. The clasp 14 may have a first arm 15 and a second arm 16, and the first arm 15 and second arm 16 may be coupled together via a base 17. The movable coupling 31 may be configured to couple the second end 13 of the dildo 11 to the clasp 14 and to enable the first end 12 of the dildo 11 to be moved relative to the clasp 14.

The device 100 may comprise one or more dildos 11. A dildo 11 may preferably comprise a generally cylindrical shape. In some embodiments, the dildo 11 may comprise a convex or rounded tip 18 which may facilitate the insertion of the dildo into a body cavity such as a vagina or anus. The tip 18 may preferably be coupled to a shaft surface 19 which may form the portions of the dildo 11 below the tip 18 which may be suitable for contacting and rubbing against interior portions of a body cavity. In some embodiments, the shaft surface 19 may be generally smooth. In further embodiments, the shaft surface 19 may comprise texturing, such as ridges, bumps, undulations, and the like which may be suitable for increasing sensation via frictional engagement between the shaft surface 19 and interior portions of a body cavity. In some embodiments, the dildo 11 may be configured with a generally phallic shape so as to have contours similar in shape to a corona and glas penis. In other embodiments, the dildo 11 may be configured with a generally cylindrical or tubular shape as shown in FIGS. 1-6. In still further embodiments, a dildo may be configured with any elongated shape suitable for insertion into portions of a body cavity.

In some embodiments, the dildo 11 may comprise a tapered section 21 which may be disposed between the first end 12 and second end 13. A tapered section 21 may form a transition from a relatively narrower section of the dildo 11 to a relatively wider section of the dildo 11. For example, the first end 12 may be relatively smaller in cross section than the second end 13, and the dildo 11 may comprise a tapered section 21 which transitions between the relatively smaller cross section to the relatively larger cross section. In further embodiments, a tapered section 21 may extend along a relatively small portion of the length (distance between first end 12 and second end 13) of the dildo 11. In alternative embodiments, a tapered section 21 may extend from the tip 18 or proximate to the tip 18 to or proximate to the second end 13.

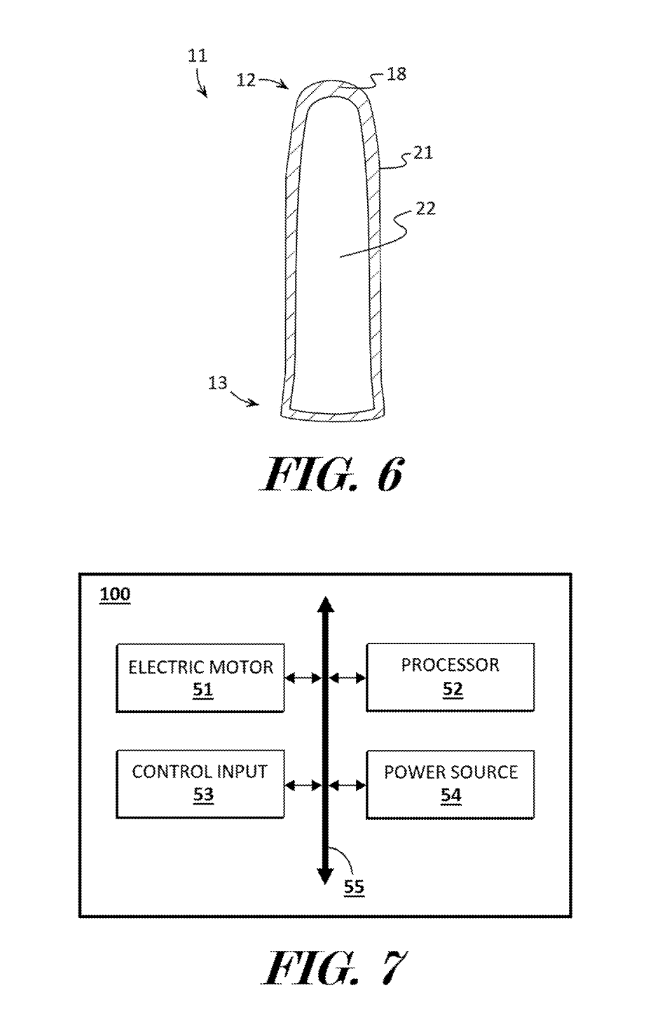

In some embodiments, the dildo 11 may comprise one or more hollow chambers 22 as shown in FIG. 6. A hollow chamber 22 may form a chamber or container within the dildo 11 which may be used to decrease the density or weight of the dildo 11. A hollow chamber 22 may be configured in any size and shape. In some embodiments, a hollow chamber 22 may contain air or other gas. In further embodiments, a hollow chamber 22 may contain a light weight foam, such as polystyrene, or other lightweight material which may be less dense or lighter in weight than other portions of the dildo 11, such as the tip 18, shaft surface 19, and/or tapered section 21. In preferred embodiments, the dildo 11 may comprise a hollow chamber 22 which may extend substantially the whole length or majority of the length of the dildo 11 and may be filled with air so that the dildo 11 may be generally hollow.

In some embodiments, the second end 13 of the dildo 11 may be removably coupled to an element of the device 100, such as to the removable coupling 31. This may allow the dildo 11 to be replaced, switched for another dildo 11, cleaned, or for any other purpose. Optionally, the removable fastener 23 may comprise a collar 35 which may be generally annular in shape and which may provide a mounting abutment for the second end 13 of the dildo 11 to contact. In further embodiments, the device 100 may comprise two or more dildos 11, optionally configured in different sizes, shapes, colors, etc., which may be removably coupled to the clasp 14 and/or to a movable coupling 31. In preferred embodiments, the device 100 may comprise a removable fastener 23 comprising threading 24 which may be used to removable couple the dildo 11 to the clasp 14 and/or to a movable coupling 31. In other embodiments, the dildo 11 may be removably coupled to the clasp 14 and/or to a movable coupling 31 with a press fit connection type of removable fastener 23, snap fit type of removable fastener 23, turn-to-lock type of removable fastener 23, or any other type of removable fastener 23 or removable coupling method. In alternative embodiments, the dildo 11 may be generally non-removable, such as with adhesive, by being integrally formed with the clasp 14 and/or a movable coupling 31, or any other coupling method.

In some embodiments, the dildo 11 may be movably coupled to the clasp 14 via a movable coupling 31 which may enable the first end 12 of the dildo 11 to be moved relative to the clasp 14. The movement provided by the movable coupling 31 allows the dildo 11 to move in synch with the movements of the wearing user while enabling the clasp 14 to be stably secured to the wearing user 200. In preferred embodiments, the movable coupling 31 may comprise a ball 32 and a socket 33 so that the movable coupling 31 may be configured as a ball joint. Optionally, the socket 33 may comprise one or more socket fingers 34 which may be configured to grip the ball 32 while allowing the ball 32 to move within the socket 33. Preferably, one or more of the socket fingers 34 and/or socket 33 may be made from or comprise a resilient material which may be generally flexible to allow the ball 32 to be removably coupled to the socket 33.

In other embodiments, a movable coupling 31 may comprise a knuckle joint, a turnbuckle, a pin joint, a pivot joint, a cotter joint, a bolted joint, a flexible material joint, a screw joint, a universal joint, a butt hinge, butterfly hinge, flush hinge, barrel hinge, concealed hinge, continuous hinge, T-hinge, strap hinge, double-acting hinge, Soss hinge, a flexible material hinge, a four-bar linkage, a scissor linkage, a collapsible pole linkage, or any other suitable mechanical or physical linkage which may couple a dildo 11 to the clasp 14 while allowing the dildo 11 to move, pivot, and/or rotate relative to the clasp 14.

In some embodiments, one or more elements of the device 100 may be made from or may comprise a resilient material. In some embodiments, a resilient material may be a natural and/or synthetic rubber material, which is flexible to allow slight deformation and resilient so as to return to its original shape after deformation. Natural rubber materials may include latex rubber, forms of the organic compound isoprene, such as polyisoprene, and the like. Synthetic rubber materials may include Polyacrylate Rubber, Ethylene-acrylate Rubber, Polyester Urethane, Bromo Isobutylene Isoprene, Polybutadiene, Chloro Isobutylene Isoprene, Polychloroprene, Chlorosulphonated Polyethylene, Epichlorohydrin, Ethylene Propylene, Ethylene Propylene Diene Monomer, Polyether Urethane, Perfluorocarbon Rubber, Fluoronated Hydrocarbon, Fluoro Silicone, Fluorocarbon Rubber, Hydrogenated Nitrile Butadiene, Polyisoprene, Isobutylene Isoprene Butyl, Acrylonitrile Butadiene, Polyurethane, Styrene Butadiene, Styrene Ethylene Butylene Styrene Copolymer, Polysiloxane, Vinyl Methyl Silicone, Acrylonitrile Butadiene Carboxy Monomer, Styrene Butadiene Carboxy Monomer, Thermoplastic Polyether-ester, Styrene Butadiene Block Copolymer, Styrene Butadiene Carboxy Block Copolymer, and the like. In other embodiments, a resilient material may be polytetrafluoroethylene (PTFE), polyethylene terephthalate (PET), high-density polyethylene (HDPE), polyvinyl chloride (PVC), polypropylene (PP), Polystyrene (PS), Polycarbonate (PC), low density polyethylene (LDPE), Polyoxymethylene (POM), Acrylonitrile butadiene styrene (ABS), Polyethylene/Acrylonitrile Butadiene Styrene (PE/ABS), Polycarbonate/Acrylonitrile Butadiene Styrene (PC/ABS), Ultra High Molecular Weight polyethylene, Polyurethanes (PU), Polyamides (PA), or any other suitable flexible natural or synthetic material including combinations of materials, which is flexible to allow slight deformation and resilient so as to return to its original shape after deformation.

Generally, the clasp 14 may be configured to be secured to a wearing user 200 so that the wearing user 200 may move the dildo 11 via hip motion in a hands-free manner. In some embodiments, the clasp 14 may have a first arm 15 and a second arm 16, and the first arm 15 and second arm 16 may be coupled together via a base 17.

In some embodiments, a first arm 15 may comprise an elongated shape which may extend generally perpendicularly away from the base 17. Preferably, a movable coupling 31 may be coupled to the clasp 14 by being coupled to the first arm 15. The first arm 15 may comprise a first arm terminus 28 which may be shaped to prevent irritation, chaffing, or other discomfort while portions of the first arm terminus 28 may rest against the clitoral region 201 of a wearing user 200. Preferably, the first arm terminus 28 may be rounded or generally blunt in shape, such as hemispherical or convex in shape.

The first arm 15 may comprise a clitoral surface 25 which may be shaped or adapted for contacting portions of a clitoral region 201 of a wearing user 200 when the clasp 14 is secured to the wearing user 200. A clitoral region 201 may be defined as tissue proximate to a clitoris, such as the clitoral hood, and optionally including the clitoris depending on variations of the female anatomy. A clitoral surface 25 may be configured in any shape and size, such as concave, convex, planar, curved, or any other shape which may be suitable for contact with the clitoral region 201. Optionally, a clitoral surface 25 may comprise texturing, such as ridges, bumps, undulations, and the like which may be suitable for increasing sensation.

In some embodiments, a second arm 16 may comprise an elongated shape which may extend generally perpendicularly away from the base 17. The second arm 16 may comprise a second arm terminus 29 which may be shaped to prevent irritation, chaffing, or other discomfort while portions of the second arm terminus 29 may rest against the anterior wall 202 of the vagina 203 of a wearing user 200. Preferably, the first arm terminus 28 may be rounded or generally blunt in shape, such as hemispherical or convex in shape so as to also facilitate insertion of portions of the second arm 16 into the vagina 203 of the wearing user 200.

The second arm 16 may comprise a vaginal surface 26 which may be shaped or adapted for contacting portions of an anterior wall 202 of a vagina 203 of a wearing user 200 when the clasp 14 is secured to the wearing user 200. A vagina anterior wall 202 may be defined as tissue within the vagina 203 which generally opposes the clitoral region 201 depending on variations of the female anatomy. A vaginal surface 26 may be configured in any shape and size, such as concave, convex, planar, curved, or any other shape which may be suitable for contact with the vagina anterior wall 202. Optionally, a vaginal surface 26 may comprise texturing, such as ridges, bumps, undulations, and the like which may be suitable for increasing sensation.

In some embodiments, a base 17 may comprise an elongated shape which may be configured to separate the first arm 15 a desired distance from the second arm 16. The base 17 may comprise a base surface 27 which may be shaped or adapted for contacting portions of the vulva and/or other tissue that is located between the clitoral region 201 and vagina 203 of a wearing user 200 when the clasp 14 is secured to the wearing user 200. A base surface 27 may be configured in any shape and size, such as concave, convex, planar, curved, or any other shape which may be suitable for contact with portions of the vulva and/or other tissue that is located between the clitoral region 201 and vagina 203. Optionally, a base surface 27 may comprise texturing, such as ridges, bumps, undulations, and the like which may be suitable for increasing sensation.

In preferred embodiments, the clasp 14 may be made from or may comprise a resilient material which may allow the clitoral surface 25 and/or vaginal surface 26 to be moved or flexed towards and/or away from each other. In some embodiments, the first arm 15 may comprise or may be made from a resilient material, and the resilient material may enable portions of the first arm 15, such as the clitoral surface 25, to be moved relative to the second arm 16. In further embodiments, the second arm 16 may comprise or may be made from a resilient material, and the resilient material may enable portions of the second arm 16, such as the vaginal surface 26, to be moved relative to the first arm 15. In still further embodiments, the base 17 may comprise or may be made from a resilient material, and the resilient material may enable portions of the second arm 16, such as the vaginal surface 26, to be moved relative to portions of the first arm 15, such as the clitoral surface 25. In yet further embodiments, the dildo 11 may comprise or may be made from a resilient material.

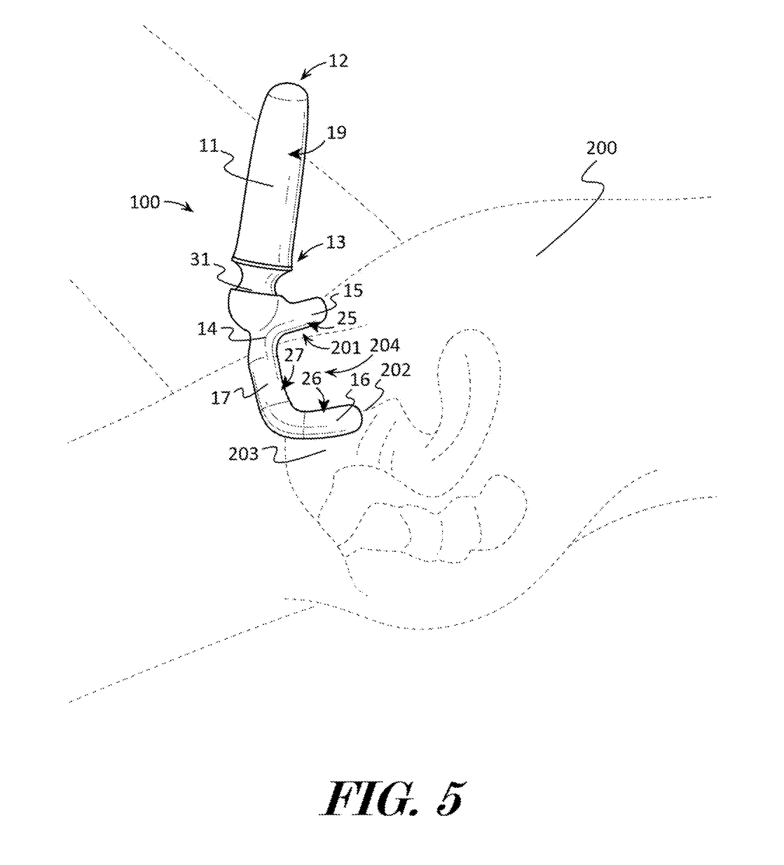

As perhaps best shown by FIG. 5, the clasp 14 may be adapted to be secured to the user by inserting the second arm 16 into the vagina 203 and in contact with the anterior wall 202 of the vagina 203 and by placing the first arm 15 in contact with the clitoral region 201 so that the pubis symphysis region 204 of the wearing user 200 is positioned between the first arm 15 and second arm 16. The pubis symphysis region 204 may include the tissue of the wearing user 200 located generally between the clitoral region 201 and anterior wall 202. In this manner, the clasp 14 may grip the pubis symphysis region 204 thereby securing the device 100 to the wearing user 200.

In preferred embodiments, portions of the second arm 16, such as the vaginal surface 26, and portions of the first arm 15, such as the clitoral surface 25, may be angled towards each other, and one or more elements of the clasp 14 may be made from or may comprise a resilient material. The resilient material(s) may enable portions of the arms 15, 16, to be flexed apart as the pubis symphysis region 204 is inserted between the arms 15, 16, and then the resilient material may draw the arms 15, 16, back towards each other to grip the wearing user 200 so that the first arm 15 is in contact with the clitoral region 201 and the second arm 16 is in contact with the anterior wall 202 of the vagina 203 (generally where the G-spot is located). In this manner, the clasp 14, when attached to the pubis symphysis region 204 provides a harness-free, stable platform for manipulating the dildo 11 while the clasp 14 also stimulates the clitoris and G-spot giving pleasure to the wearing user 200.

In further embodiments, a first arm 15 may be coupled to the base 17 and/or a second arm 16 may be coupled to the base with any type of movable coupling, such as which may be used for movable coupling 31, which may enable portions of the arms 15, 16, to be moved apart as the pubis symphysis region 204 is inserted between the arms 15, 16, and then may draw the arms 15, 16, back towards each other to grip the wearing user 200 so that the first arm 15 is in contact with the clitoral region 201 and the second arm 16 is in contact with the anterior wall 202 of the vagina 203 (generally where the G-spot is located).

Turning now to FIG. 7, in some embodiments, the device 100 may comprise one or more electrical components, such as an electric motor 51, a processor 52, a control input 53, and/or a power source 54. In preferred embodiments, one or more of the components (51, 52, 53, 54) may be operable to cause one or more elements of the device 100, such as the dildo 11 and/or clasp 14, to allow elements of the device 10 to vibrate, rotate, or otherwise move for further user pleasure and sensation.

In some embodiments, the device 100 may comprise one or more electric motors 51 which may be configured to vibrate, shake, rotate, or produce any other series of rapid and repeated movements. An electric motor 51 may be coupled to any element of the device 100, such as the dildo 11 and/or clasp 14, to allow elements of the device 10 to vibrate, rotate, or otherwise move for further user pleasure and sensation. In some embodiments, an electric motor 51 may comprise a long life brushless (BLDC) vibration motor, a coin or pancake vibration motor, an encapsulated vibration motor, an enclosed vibration motor, a pager motor, an eccentric rotating mass (ERM) motor, a linear resonant actuator (LRA), a printed circuit board (PCB) mounted vibration motor, or any other electrical device capable of producing a series of rapid and repeated movements. In further embodiments, an electric motor 51 may comprise a brushed DC motor, brushless DC motor, switched reluctance motor, universal motor, AC polyphase squirrel-cage or wound-rotor induction motor, AC SCIM split-phase capacitor-start motor, AC SCIM split-phase capacitor-run motor, AC SCIM split-phase auxiliary start winding motor, AC induction shaded-pole motor, wound-rotor synchronous motor, hysteresis motor, synchronous reluctance motor, pancake or axial rotor motor, stepper motor, or any other type of motor.

In some embodiments, the device 100 may comprise a processor 52 which may be configured to control the functions of one or more electric motors 51 of the device 100. Preferably, the processor 52 may be programable by a user and/or comprise one or more programs which may control the functions of one or more electric motors 51 of the device 100. For example, the processor 52 may be configured to pulse the operation of an electric motor 51 and to vary the speed at which an electric motor 51 may operate. The processor 52 can be any custom made or commercially available processor, a central processing unit (CPU), an auxiliary processor among several processors, a semiconductor-based microprocessor (in the form of a microchip or chip set), or generally any device for executing software instructions. In some embodiments, a processor 52 may comprise a small computer on a single integrated circuit typically used for embedded applications and preferably comprising a processor core, memory, and programmable input/output peripherals. Program memory in the form of NOR flash or OTP ROM is may also be included on chip, as well as a typically small amount of RAM.

In some embodiments, the device 100 may comprise one or more control inputs 53 that a user may interact with, such as turnable control knobs, depressible button type switches, a key pad, slide type switches, rocker type switches, or any other suitable input that may be used to modulate electricity between components or to otherwise control functions of the device 100, such as to turn the device 100 on and off. In some embodiments, a control input 53 may allow a user to provide input to an electric motor 51 and/or processor 52 which may enable a user to control the functions of one or more electric motors 51 of the device 100. For example, by interacting with a control input 53, a user may cause the device 100 to provide pulsing operation of an electric motor 51 and/or to vary the speed at which an electric motor 51 may operate.

In some embodiments, the device 100 may comprise a power source 54 which may provide electrical power to any component that may require electrical power. A power source 54 may comprise a battery, such as a lithium ion battery, nickel cadmium battery, alkaline battery, or any other suitable type of battery, a fuel cell, a capacitor, a super capacitor, or any other type of energy storing and/or electricity releasing device. In further embodiments, a power source 54 may comprise a power cord, kinetic or piezo electric battery charging device, a solar cell or photovoltaic cell, and/or inductive charging or wireless power receiver. In further embodiments, a power source 54 may comprise a power charging and distribution module which may be configured to control the recharging of the power source 54, discharging of the power source 54, and/or distribution of power to one or more components of the device 100 that may require electrical power.

The components and elements (51, 52, 53, and 54) may be communicatively coupled via a local interface 55. The local interface 55 can be, for example but not limited to, one or more buses, circuit boards, integrated circuits, or other wired or wireless connections, as is known in the art. The local interface 55 can have additional elements, which are omitted for simplicity, such as controllers, buffers (caches), drivers, repeaters, and receivers, among many others, to enable communications.

While some exemplary shapes and sizes have been provided for elements of the device 100, it should be understood to one of ordinary skill in the art that the dildo 11, clasp 14, movable coupling 31, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A pleasure clasp device, the device comprising:
a dildo having a first end and a second end;
a clasp having a first arm and a second arm, wherein the first arm and second arm are coupled together via a base; and
a movable coupling, the movable coupling configured to couple the second end of the dildo to the clasp and to enable the first end of the dildo to be moved relative to the clasp.

2. The device of claim 1, wherein the movable coupling comprises a ball and a socket.

3. The device of claim 1, wherein the first arm comprises a resilient material, and wherein the resilient material enables portions of the first arm to be moved relative to the second arm.

4. The device of claim 1, wherein the second arm comprises a resilient material, and wherein the resilient material enables portions of the second arm to be moved relative to the first arm.

5. The device of claim 1, wherein the base comprises resilient material, and wherein the resilient material enables portions of the second arm to be moved relative to the first arm.

6. The device of claim 1, wherein the dildo comprises tapered section.

7. The device of claim 1, wherein the second end is removably coupled to movable coupling.

8. The device of claim 1, wherein the dildo comprises a hollow chamber.

9. The device of claim 1, further comprising an electric motor.

10. The device of claim 1, wherein the first arm comprises a clitoral surface for contacting portions of a clitoral region.

11. The device of claim 1, wherein the second arm comprises a vaginal surface for contacting portions of an anterior wall of a vagina.

12. A pleasure clasp device for use with a wearing user having a vagina, a clitoral region, and a pubis symphysis region, the device comprising:
a dildo having a first end and a second end;
a clasp having a first arm and a second arm, wherein the first arm and second arm are coupled together via a base, and wherein the clasp adapted to be secured to the user by inserting the second arm into the vagina and placing the first arm in contact with the clitoral region so that the pubis symphysis region is positioned between the first arm and second arm; and
a movable coupling, the movable coupling configured to couple the second end of the dildo to the clasp and to enable the first end of the dildo to be moved relative to the clasp.

13. The device of claim 12, wherein the movable coupling comprises a ball and a socket.

14. The device of claim 12, wherein the first arm comprises a resilient material, and wherein the resilient material enables portions of the first arm to be moved relative to the second arm.

15. The device of claim 12, wherein the second arm comprises a resilient material, and wherein the resilient material enables portions of the second arm to be moved relative to the first arm.

16. The device of claim 12, wherein the base comprises resilient material, and wherein the resilient material enables portions of the second arm to be moved relative to the first arm.

17. The device of claim 12, wherein the dildo comprises tapered section.

18. The device of claim 12, further comprising an electric motor.

19. The device of claim 12, wherein the first arm comprises a clitoral surface for contacting portions of the clitoral region.

20. The device of claim 12, wherein the second arm comprises a vaginal surface for contacting portions of an anterior wall of the vagina.
